(19) United States
(12) Patent Application Publication
(10) Pub. No.: US 2012/0289678 A1
(43) Pub. Date: Nov. 15, 2012

(54) METHOD OF MAKING POLYARYLENE IONOMERS AND MEMBRANES

(75) Inventor: Mark F. Teasley, Landenberg, PA (US)

(73) Assignee: E.I. Du Pont De Nemours and Company, Wilmington, DE (US)

(21) Appl. No.: 13/519,452

(22) PCT Filed: Dec. 28, 2010
(86) PCT No.: PCT/US10/62234

§ 371 Date: Jun. 27, 2012

Related U.S. Application Data
(60) Provisional application No. 61/290,618, filed on Dec. 29, 2009.

(51) Int. Cl. C08G 75/20

(52) U.S. Cl. 528/391

(57) ABSTRACT

Described herein is the preparation of polyarylene ionomers copolymers, both polysulfones and sulfonimide containing, useful as membranes in electrochemical cells.

### FIELD OF THE INVENTION

Described herein is the preparation of polyarylene ionomers copolymers useful as membranes in electrochemical cells.

### BACKGROUND OF THE INVENTION

Polymer electrolyte membrane fuel cells (PEMFC) are expected to provide higher efficiencies, fewer environmental pollutants, and reduced operating and maintenance costs than traditional power sources. An important component of a PEMFC is a polymer electrolyte membrane (PEM). The range of potential candidates for use as membrane materials in PEMFCs is limited by a number of requirements, including chemical, thermal, and mechanical stability, high ionic conductivity, and low reactant permeability. Developments have been made in the use of sulfonic acid functionalized polymers, including membranes such as Nafion® perfluorosulfonic acid membranes.

Known membranes made from sulfonic acid functionalized polymers have been found to have less than desirable performance at temperatures greater than 100° C. due, in part, to the dependence of the membranes on water for proton conduction. Above 100° C., pressure constraints limit the amount of water that can be used to hydrate a membrane. At relatively low levels of humidity, insufficient water is present within the membrane to support the transport of protons. In addition to improved performance at higher temperatures, it is also desirable to have improved mechanical stability at such temperatures.

The conductivity of the membranes can be recovered to a degree by reducing the equivalent weight of the ionomers, but if taken too far this can lead to excessive water swell and the loss of their membrane forming properties.

Considerably work has been done to develop aromatic ionomers as alternatives to perfluorosulfonic acid membranes, but they tend to suffer from even lower conductivity at lower humidity and higher water swell.

New methods for the manufacture of such ionomers are desired.

### SUMMARY OF THE INVENTION

The invention provides a process to prepare a copolymer comprising polymerizing a monomer of Formula (II)

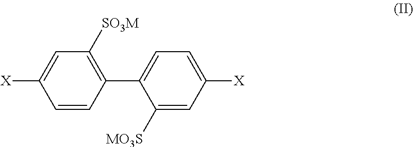

and a monomer of Formula (III)

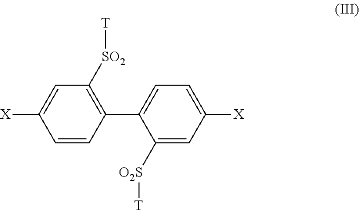

wherein T is a bulky aromatic group, X is independently Br or Cl, and M is one or more of monovalent cation.

In embodiments of the invention, the polymerization is done in the presence of a zerovalent transition metal and a neutral ligand in the form of a complex. The zerovalent transition metal may be palladium or nickel.

In embodiments of the invention, the zerovalent transition metal is bis(1,5-cyclooctadiene)nickel(0) and the neutral ligand is 2,2′-bipyridine. There may also be an accelerator is present, and the polymerization may be performed in a solvent.

### DETAILED DESCRIPTION

Described herein is a method of making a copolymer comprising repeating units of Formula (I):

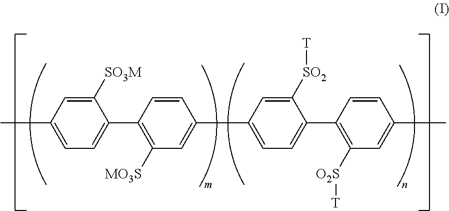

wherein T is a bulky aromatic group, M is one or more of monovalent cation and m and n are integers indicating the number of repeat units in the copolymer.

By bulky aromatic group is meant an aromatic carbocyclic group having a single ring (e.g., phenyl), multiple rings (e.g., biphenyl), or multiple condensed rings in which at least one is aromatic, (e.g., 1,2,3,4-tetrahydronaphthyl, naphthyl, anthryl, or phenanthryl). The bulky aromatic group can be optionally substituted with a non-reactive group, such as alkyl, other aromatic groups, and other non-reactive functional groups such as ethers. The monovalent cation M can be a single cation or a mixture of different cations. In one embodiment, M is K, Na, Li, or H and T is phenyl.

The term “copolymer” is intended to include oligomers and copolymers having two or more different repeating units. A copolymer having repeating units derived from a first monomer “X-A-X” and a second monomer “X-B-X” will have repeating units (-A-) and (-B-). The copolymers described herein can be random or block copolymers. In one embodiment, the copolymer has a weight average molecular weight of at least 30,000.

Other repeat units may additionally be present in the copolymer, including but not limited to those of formula below, as disclosed in WO2008/127320

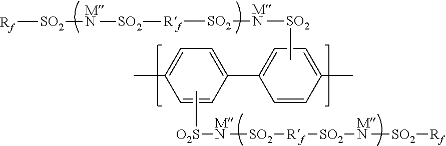

wherein R_{f} and R′_{f} are independently a straight chain, branched or cyclic, perfluorinated alkylene groups having from 1 to 20 carbon atoms and optionally substituted with one or more ether oxygens or halogens; m is 0 to 6; and M″ is one or more of monovalent cation. The monovalent cation M″ can be a single cation or a mixture of different cations. In one embodiment, the M″ is K, Na, Li, or H. In another embodiment, m is 0.

By “perfluorinated alkylene” it is meant a divalent group containing carbon and fluorine connected by single bonds, optionally substituted with ether oxygens or other halogens, and containing two free valences to different carbon atoms. It can be linear, branched, or cyclic. In one embodiment R_{f} and R′_{f} are independently (that is, can be the same or different) a perfluorinated alkylene groups having from 1 to 10 carbon atoms. In another embodiment, R_{f} and R′_{f} are independently a linear, perfluorinated alkylene groups having from 1 to 4 carbon atoms.

The practical upper limit to the number of monomeric units in the polymer is determined in part by the desired solubility of a polymer in a particular solvent or class of solvents. As the total number of monomeric units increases, the molecular weight of the polymer increases. The increase in molecular weight is generally expected to result in a reduced solubility of the polymer in a particular solvent. Moreover, in one embodiment, the number of monomeric units at which a polymer becomes substantially insoluble in a given solvent is dependent in part upon the structure of the monomer. In one embodiment, the number of monomeric units at which a copolymer becomes substantially insoluble in a given solvent is dependent in part upon the ratio of the comonomers. For example, a polymer composed of flexible monomers may become substantially insoluble in an organic solvent if the resulting polymer becomes too rigid in the course of polymerization. As another example, a copolymer composed of several monomers may become substantially insoluble in an organic solvent when ratio of rigid monomeric units to flexible monomeric units is too large. The selection of polymer molecular weight, polymer and copolymer composition, and a solvent is within the purview of one skilled in the art.

The monomers that can be used to prepare copolymers of Formula (I), and the reactants used to prepare the monomers, may be obtained commercially or be prepared using any known method in the art or those disclosed herein.

An embodiment of the invention is a process to prepare a copolymer comprising polymerizing a monomer of Formula (II)

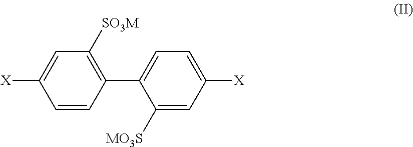

and a monomer of Formula (III)

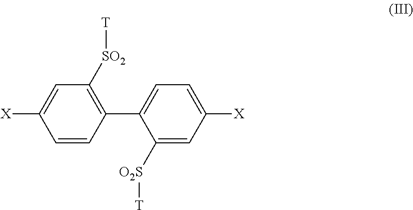

wherein M and T are as described above and X is independently Br or Cl. Other monomers may additionally be used in the process, including but not limited to those of formula below, as disclosed in WO2008/127320, as described herein.

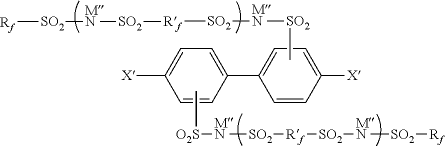

in which X′ are leaving groups that participate in carbon-carbon bond-forming reactions such as but not limited to chlorine, bromine, iodine, methanesulfonate, trifluoromethanesulfonate, boronic acid, boronate salts, boronic acid esters, and boranes, R_{f} and R′_{f} are independently a straight chain, branched or cyclic, perfluorinated alkylene groups having from 1 to 20 carbon atoms and optionally substituted with one or more ether oxygens or halogens; m is 0 to 6; and M′ is one or more of monovalent cation. Either or both of X or X′ are preferably Cl.

The polymerizations as described herein can generally be performed by synthetic routes in which the leaving groups of the monomers are eliminated in carbon-carbon bond-forming reactions. Such carbon-carbon bond-forming reactions are typically mediated by a zerovalent transition metal complex that contains neutral ligands. In one embodiment, the zerovalent transition metal complex contains nickel or palladium.

The monomers of Formula (II) and (III) may also be reacted to form larger monomeric units that are then polymerized alone or with other monomers to form the polymers disclosed herein. For example, a copolymer (-A-)ₓ(-B-)_{y} may be formed by copolymerizing monomer X-A-X with monomer X-B-X, or by forming larger monomer X-A-B-X and polymerizing that monomer. In both cases, the resulting polymer is considered a copolymer derived from monomer X-A-X and monomer X-B-X.

Neutral ligands are defined as ligands that are neutral, with respect to charge, when formally removed from the metal in their closed shell electronic state. Neutral ligands contain at least one lone pair of electrons, a pi-bond, or a sigma bond that is capable of binding to the transition metal. For the processes described herein, the neutral ligand may also be a combination of two or more neutral ligands. Neutral ligands may also be polydentate when more than one neutral ligand is connected via a bond or a hydrocarbyl, substituted hydrocarbyl or a functional group tether. A neutral ligand may be a substituent of another metal complex, either the same or different, such that multiple complexes are bound together. Neutral ligands can include carbonyls, thiocarbonyls, carbenes, carbynes, allyls, alkenes, olefins, cyanides, nitriles, carbon monoxide, phosphorus containing compounds such as phosphides, phosphines, or phosphites, acetonitrile, tetrahydrofuran, tertiary amines (including heterocyclic amines), ethers, esters, phosphates, phosphine oxides, and amine oxides.

Three synthetic methods based on zerovalent transition metal compounds that can be used to prepare the polymers are described herein. In each method, the zerovalent transition metal compound that is the active species in carbon-carbon bond formation can be introduced directly into the reaction, or can be generated in situ under the reaction conditions from a precursor transition metal compound and one or more neutral ligands.

In a first synthetic method, as described in Yamamoto, Progress in Polymer Science, Vol. 17, p 1153 (1992), the dihalo derivatives of the monomers are reacted with stoichiometric amounts of a zerovalent nickel compound, such as a coordination compound like bis(1,5-cyclooctadiene)nickel(0), and a neutral ligand, such as triphenylphosphine or 2,2′-bipyridine. These components react to generate the zerovalent nickel compound that is the active species in the polymerization reaction. A second neutral ligand, such as 1,5-cyclooctadiene, can be used to stabilize the active zerovalent nickel compound.

In a second synthetic method, as described in U.S. Pat. No. 5,962,631, Ioyda et al., Bulletin of the Chemical Society of Japan, Vol. 63, p. 80 (1990), and Colon et al., Journal of Polymer Science, Part A, Polymer Chemistry Edition, Vol. 28, p. 367 (1990), the dihalo derivatives of the monomers are reacted with catalytic amounts of a divalent nickel compound in the presence of one or more neutral ligands in the presence of stoichiometric amounts of a material capable of reducing the divalent nickel ion to zerovalent nickel.

The catalyst is formed from a divalent nickel salt. The nickel salt may be any nickel salt that can be converted to the zerovalent state under reaction conditions. Suitable nickel salts are the nickel halides, typically nickel dichloride or nickel dibromide, or coordination compounds, typically bis(triphenylphosphine)nickel dichloride or (2,2′-bipyridine)nickel dichloride. The divalent nickel salt is typically present in an amount of about 0.01 mole percent or greater, more typically about 0.1 mole percent or greater or 1.0 mole percent or greater. The amount of divalent nickel salt present is typically about 30 mole percent or less, more typically about 15 mole percent or less based on the amount of monomers present.

The polymerization is performed in the presence of a material capable of reducing the divalent nickel ion to the zerovalent state. Suitable material includes any metal that is more easily oxidized than nickel. Suitable metals include zinc, magnesium, calcium and lithium, with zinc in the powder form being typical. At least stoichiometric amounts of reducing agent based on the monomers are required to maintain the nickel species in the zerovalent state throughout the reaction. Typically, about 150 mole percent or greater, more typically about 200 mole percent or greater, or about 250 mole percent or greater is used. The reducing agent is typically present in an amount of about 500 mole percent or less, about 400 mole percent or less, or about 300 mole percent or less based on the amount of monomer.

Also present are one or more compounds capable of acting as a ligand. Suitable ligands are neutral ligands as described above, and include trihydrocarbylphosphines. Typical ligands are monodentate, such as triaryl or trialkylphosphines like triphenylphosphine, or bidentate, such as 2,2′-bipyridine. A compound capable of acting as a monodentate ligand is typically present in an amount of from about 10 mole percent or greater, or about 20 mole percent or greater based on the monomer. A compound capable of acting as a monodentate ligand is typically present in an amount of about 100 mole percent or less, about 50 mole percent or less, or about 40 mole percent or less. A compound capable of acting as a bidentate ligand is typically present in an amount that is about a molar equivalent or greater based on the divalent nickel salt. Alternatively, the bidentate ligand can be incorporated into the nickel salt as a coordination compound as described above.

In a third synthetic method, as described in PCT application WO 00/53656 and U.S. Pat. No. 6,353,072, a dihalo derivative of one monomer is reacted with a derivative of another monomer having two leaving groups selected from boronic acid (—B(OH₂) or boronate salt, boronic acid esters (—BOR₂) or (—B(ORO)), and boranes (—BR₂), where R is generally a hydrocarbyl group, in the presence of a catalytic amount of a zerovalent palladium compound containing a neutral ligand as described above, such as tetrakis(triphenylphosphine)palladium(0). If the leaving group is a boronic ester or borane group, the reaction mixture should include sufficient water or an organic base to hydrolyze the boronic ester or borane group to the corresponding boronic acid group. The diboronic derivative of a monomer can be prepared from the dihalo derivative by known methods, such as those described in Miyaura et al., Synthetic Communication, Vol. 11, p. 513 (1981) and Wallow et al., American Chemical Society, Polymer Preprint, Vol. 34, (1), p. 1009 (1993).

All of the synthetic methods discussed herein can be performed in the presence of a compound capable of accelerating the reaction. Suitable accelerators include alkali metal halides such as sodium bromide, potassium bromide, sodium iodide, tetraethylammonium iodide, and potassium iodide. The accelerator is used in a sufficient amount to accelerate the reaction, typically 10 mole percent to 100 mole percent based on the monomer.

The reactions are typically run in a suitable solvent or mixture of solvents, that is a solvent that is not detrimental to catalyst, reactant and product, and preferably one is which the reactants and products are soluble. Suitable solvents include N,N-dimethylformamide (DMF), toluene, tetrahydrofuran (THF), acetone, anisole, acetonitrile, N,N-dimethylacetamide (DMAc), and N-methylpyrrolidinone (NMP). The amount of solvent used in this process can vary over a wide range. Generally, it is desired to use as little solvent as possible. The reactions are typically conducted in the absence of oxygen and moisture, as the presence of oxygen can be detrimental to the catalyst and the presence of a significant amount of water could lead to premature termination of the process. More typically, the reaction is performed under an inert atmosphere such as nitrogen or argon.

The reactions can be performed at any temperature at which the reaction proceeds at a reasonable rate and does not lead to degradation of the product or catalyst. Generally, the reaction is performed at a temperature of about 20° C. to about 200° C., more typically less than 100° C. The reaction time is dependent upon the reaction temperature, the amount of catalyst and the concentration of the reactants, and is usually about 1 hour to about 100 hours.

The polymers prepared by the disclosed methods can be recovered according to conventional techniques including filtration and precipitation using a non-solvent. They also can be dissolved or dispersed in a suitable solvent for further processing. They may be useful in many applications such as proton-exchange membranes and electrode binders for fuel cells, in lithium batteries (as the lithium salt form), applications requiring charge-transport phenomena, such as in capacitors or in the preparation of certain components in light-emitting displays, and as engineering resin or fibers.

The polymers can be formed into membranes using any conventional method such as but not limited to solution or dispersion film casting or extrusion techniques. The membrane thickness can be varied as desired for a particular application. Typically, for electrochemical uses, the membrane thickness is less than about 350 μm, more typically in the range of about 25 μm to about 175 μm. If desired, the membrane can be a laminate of two polymers such as two polymers having different equivalent weight. Such films can be made by laminating two membranes. Alternatively, one or both of the laminate components can be cast from solution or dispersion. When the membrane is a laminate, the chemical identities of the monomer units in the additional polymer can independently be the same as or different from the identities of the analogous monomer units of the first polymer. One of ordinary skill in the art will understand that membranes prepared from the dispersions may have utility in packaging, in non-electrochemical membrane applications, as an adhesive or other functional layer in a multi-layer film or sheet structure, and other classic applications for polymer films and sheets that are outside the field of electrochemistry. For the purposes of the present invention, the term “membrane”, a term of art in common use in electrochemistry, is synonymous with the terms “film” or “sheet”, which are terms of art in more general usage, but refer to the same articles.

The membrane may optionally include a porous support or reinforcement for the purposes of improving mechanical properties, for decreasing cost and/or other reasons. The porous support may be made from a wide range of materials, such as but not limited to non-woven or woven fabrics, using various weaves such as the plain weave, basket weave, leno weave, or others. The porous support may be made from glass, hydrocarbon polymers such as polyolefins, (e.g., polyethylene, polypropylene, polybutylene, and copolymers), and perhalogenated polymers such as polychlorotrifluoroethylene. Porous inorganic or ceramic materials may also be used. For resistance to thermal and chemical degradation, the support typically is made from a fluoropolymer, more typically a perfluoropolymer. For example, the perfluoropolymer of the porous support can be a microporous film of polytetrafluoroethylene (PTFE) or a copolymer of tetrafluoroethylene. Microporous PTFE films and sheeting are known that are suitable for use as a support layer. For example, U.S. Pat. No. 3,664,915 discloses uniaxially stretched film having at least 40% voids. U.S. Pat. Nos. 3,953,566, 3,962,153 and 4,187,390 disclose porous PTFE films having at least 70% voids. Impregnation of expanded PTFE (ePTFE) with perfluorinated sulfonic acid polymer is disclosed in U.S. Pat. Nos. 5,547,551 and 6,110,333. ePTFE is available under the trade name “Goretex” from W. L. Gore and Associates, Inc., Elkton, Md., and under the trade name “Tetratex” from Donaldson Company, Inc., Bloomington, Minn.

Membrane electrode assemblies (MEA) and fuel cells therefrom are well known in the art and can comprise any of the membranes described above. One suitable embodiment is described herein. An ionomeric polymer membrane is used to form a MEA by combining it with a catalyst layer, comprising a catalyst such as platinum, which is unsupported or supported on carbon particles, a binder such as Nafion®, and a gas diffusion backing. The catalyst layers may be made from well-known electrically conductive, catalytically active particles or materials and may be made by methods well known in the art. The catalyst layer may be formed as a film of a polymer that serves as a binder for the catalyst particles. The binder polymer can be a hydrophobic polymer, a hydrophilic polymer, or a mixture of such polymers. The binder polymer is typically ionomeric and can be the same ionomer as in the membrane. A fuel cell is constructed from a single MEA or multiple MEAs stacked in series by further providing porous and electrically conductive anode and cathode gas diffusion backings, gaskets for sealing the edge of the MEA(s), which also provide an electrically insulating layer, graphite current collector blocks with flow fields for gas distribution, aluminum end blocks with tie rods to hold the fuel cell together, an anode inlet and outlet for fuel such as hydrogen, and a cathode gas inlet and outlet for oxidant such as air.

### EXAMPLES

### Through-Plane Conductivity Measurement

The through-plane conductivity of a membrane was measured by a technique in which the current flowed perpendicular to the plane of the membrane. The lower electrode was formed from a 12.7 mm diameter stainless steel rod and the upper electrode was formed from a 6.35 mm diameter stainless steel rod. The rods were cut to length, machined with grooves to accept “O”-ring seals, and their ends were polished and plated with gold. The lower electrode had six grooves (0.68 mm wide and 0.68 mm deep) to allow humidified air flow. A stack was formed consisting of lower electrode/GDE/membrane/GDE/upper electrode. The GDE (gas diffusion electrode) was a catalyzed ELAT® (E-TEK Division, De Nora North America, Inc., Somerset, N.J.) comprising a carbon cloth with microporous layer, platinum catalyst, and 0.6-0.8 mg/cm² Nafion® application over the catalyst layer. The lower GDE was punched out as a 9.5 mm diameter disk, while the membrane and the upper GDE were punched out as 6.35 mm diameter disks to match the upper electrode. The stack was assembled and held in place within a 46.0×21.0 mm×15.5 mm block of annealed glass-fiber reinforced machinable PEEK that had a 12.7 mm diameter hole drilled into the bottom of the block to accept the lower electrode and a concentric 6.4 mm diameter hole drilled into the top of the block to accept the upper electrode. The PEEK block also had straight threaded connections. Male connectors with SAE straight thread and tubing to “O”-ring seals (1M1SC2 and 2M1SC2 from Parker Instruments) were used to connect to the variable humidified air feed and discharge. The fixture was placed into a small vice with rubber grips and 10 lb-in of torque was applied using a torque wrench. The fixture containing the membrane was connected to 1/16″ tubing (humidified air feed) and ⅛″ tubing (humidified air discharge) inside a thermostated forced-convection oven for heating. The temperature within the vessel was measured by means of a thermocouple.

Water was fed from an Isco Model 500D syringe pump with pump controller. Dry air was fed (200 sccm standard) from a calibrated mass flow controller (Porter F201 with a Tylan® RO-28 controller box). To ensure water evaporation, the air and the water feeds were mixed and circulated through a 1.6 mm ( 1/16″), 1.25 m long piece of stainless steel tubing inside the oven. The resulting humidified air was fed into the 1/16″ tubing inlet. The cell pressure (atmospheric) was measured with a Druck® PDCR 4010 Pressure Transducer with a DPI 280 Digital Pressure Indicator. The relative humidity was calculated assuming ideal gas behavior using tables of the vapor pressure of liquid water as a function of temperature, the gas composition from the two flow rates, the vessel temperature, and the cell pressure. The grooves in the lower electrode allowed flow of humidified air to the membrane for rapid equilibration with water vapor. The real part of the AC impedance of the fixture containing the membrane, Rₛ, was measured at a frequency of 100 kHz using a Solartron SI 1260 Impedance/Gain Phase Analyzer and SI 1287 Electrochemical Interphase with ZView 2 and ZPlot 2 software (Solartron Analytical, Farnborough, Hampshire, GU14 0NR, UK). The fixture short, R_{f}, was also determined by measuring the real part of the AC impedance at 100 kHz for the fixture and stack assembled without a membrane sample. The conductivity, K, of the membrane was then calculated as

κ=t/((Rₛ−R_{f})*0.317 cm²),

where t was the thickness of the membrane in cm.

### In-Plane Conductivity Measurement

The in-plane conductivity of a membrane was measured under conditions of controlled relative humidity and temperature by a technique in which the current flowed parallel to the plane of the membrane. A four-electrode technique was used similar to that described in an article entitled “Proton Conductivity of Nafion® 117 As Measured by a Four-Electrode AC Impedance Method” by Y. Sone et al., J. Electrochem. Soc., vol. 143, pg. 1254 (1996), which is herein incorporated by reference. A lower fixture was machined from annealed glass-fiber reinforced PEEK to have four parallel ridges containing grooves that supported and held four 0.25 mm diameter platinum wire electrodes, and slots that allowed for circulation of humidified air. The distance between the two outer electrodes was 25 mm, while the distance between the two inner electrodes was 10 mm. A strip of membrane was cut to a width between 10 and 16 mm and a length sufficient to cover and extend slightly beyond the outer electrodes, and placed on top of the platinum electrodes. An upper fixture which had ridges corresponding in position to those of the bottom fixture, was placed on top and the two fixtures were clamped together so as to push the membrane into contact with the platinum electrodes. The fixture containing the membrane was placed inside a small pressure vessel (pressure filter housing), which was placed inside a thermostated forced-convection oven for heating. The temperature within the vessel was measured by means of a thermocouple.

Water was fed from an Isco Model 500D syringe pump with pump controller. Dry air was fed (200 sccm standard) from a calibrated mass flow controller (Porter F201 with a Tylan® RO-28 controller box). To ensure water evaporation, the air and the water feeds were mixed and circulated through a 1.6 mm ( 1/16″), 1.25 m long piece of stainless steel tubing inside the oven. The resulting humidified air was fed into the inlet of the pressure vessel. The total pressure within the vessel (100 to 345 kPa) was adjusted by means of a GO BP-3 series back-pressure regulator. The cell pressure was measured with a Druck® PDCR 4010 Pressure Transducer with a DPI 280 Digital Pressure Indicator. The relative humidity was calculated assuming ideal gas behavior using tables of the vapor pressure of liquid water as a function of temperature, the gas composition from the two flow rates, the vessel temperature, and the total pressure. The slots in the lower and upper parts of the fixture allowed for circulation of humidified air to the membrane for rapid equilibration with water vapor. Current was applied between the outer two electrodes while the resultant voltage was measured between the inner two electrodes. The real part of the AC impedance (resistance) between the inner two electrodes, R, was measured at a frequency of 1000 Hz using a Solartron SI 1260 Impedance/Gain Phase Analyzer and SI 1287 Electrochemical Interphase with ZView 2 and ZPlot 2 software (Solartron Analytical, Farnborough, Hampshire, GU14 0NR, UK). The conductivity, κ, of the membrane was then calculated as

κ=1.00 cm/(R*t*w),

where t was the thickness of the membrane and w was its width (both in cm).

2,5-Dibromo-benzene-sulfonic acid, sodium salt was prepared by modification of the published procedure of H. Borns, Annalen der Chemie 1877, 187, 350. 2,5-Dibromo-benzene-sulfonyl chloride was prepared by modification of the published procedure of E. H. Huntress and F. H. Carten, J. Am. Chem. Soc. 1940, 62, 511. 4,4′-Dibromo-biphenyl-2,2′-disulfonyl dichloride was prepared by modification of the published procedure of C. Courtot and C. C. Chang, Bull. Soc. Chim. Fr. 1931, 1047.

### 2,5-Dibromo-benzene-sulfonic acid, sodium salt (D100016-122)

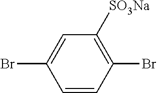

A 300 mL round-bottom flask equipped with a reflux condenser, stirring bar, and gas inlet was charged with 1,4-dibromo-benzene (118 g, 0.50 moles) and 30% fuming sulfuric acid (76 mL). The mixture was heated to 150° C. for 3 hours under nitrogen to give a clear solution. The solution was cooled to room temperature to give a solidified mass and transferred into a beaker with water to give a slurry. The slurry was treated with 50% sodium hydroxide solution (130 g) and diluted to 900 mL with water with heating to disperse the precipitated solids. The mixture was cooled to room temperature and the solids collected by vacuum filtration under a rubber dam. The solids were washed with two times with isopropanol (200 mL) and air dried on the filter then dried under vacuum at 100° C. to give 159 g (93% crude yield). The product was recrystallized from ethanol/water (4:1) and dried under vacuum at 150° C. to give 146 g (86% yield) of 2,5-dibromo-benzene-sulfonic acid, sodium salt. ¹H NMR (DMSO-d₆): 7.42 (dd, 8.4, 2.6 Hz, 1H), 7.53 (d, 8.4 Hz, 1H), 8.01 (d, 2.6 Hz, 1H).

### Activation of Copper Powder

Copper powder was activated according to the procedure in Vogel's Textbook of Practical Organic Chemistry, 4^{th} Edition, 1981, Longman (London), page 285-286. Copper bronze (50 g, Aldrich Chemical Company, Milwaukee, Wis.) was stirred for 10-20 minutes with a solution of iodine (10 g) dissolved in acetone (500 mL) to give a gray mixture. The copper was filtered off, washed acetone, and added to a solution of hydrochloric acid (150 mL) and acetone (150 mL). The mixture was stirred until the gray solids dissolved then the copper was filtered off and washed well with acetone. The activated copper solids were dried under high vacuum and transferred to a glove box for storage and handling.

### Example 1

### D100016-126

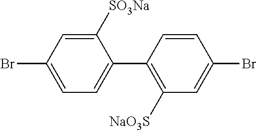

Inside a glove box, a 500 mL round-bottom flask equipped with a reflux condenser, stirring bar, and gas inlet was charged with 2,5-dibromo-benzene-sulfonic acid, sodium salt (73 g, 0.216 moles), activated copper bronze (27 g, 0.43 moles), and DMAc (200 mL). The mixture was heated to 120° C. overnight under nitrogen. The mixture was poured into water (1 L) and the solid removed by vacuum filtration. The filtrate was evaporated and the residue dried at 100° C. under vacuum. The solids were recrystallized from acetonitrile/water (10:1) after treating with decolorizing carbon and dried under vacuum at 60-150° C. to give 48.13 g (86% yield) of 4,4′-dibromo-biphenyl-2,2′-disulfonic acid, sodium salt. ¹H NMR (DMSO-d₆): 7.19 (d, 8.3 Hz, 2H), 7.42 (dd, 8.3 and 2.1 Hz, 2H), 7.96 (d, 2.1 Hz, 2H).

### 2,5-Dibromo-benzene-sulfonyl chloride (D100016-114)

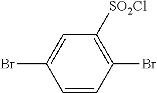

A 300 mL round-bottom flask equipped with a reflux condenser, stirring bar, and gas inlet was charged with 1,4-dibromo-benzene (50 g, 0.21 moles) and chlorosulfonic acid (100 mL). The mixture was heated to 90° C. for 2 hours under nitrogen to give a clear solution. The solution was cooled to room temperature and carefully poured onto ice (1 kg) to give a precipitate. The solids were collected by vacuum filtration, washed well with water, and air dried on the filter then dried under vacuum at 50° C. to give 68.36 g. The product was recrystallized from cyclohexane after treating with decolorizing carbon, collected by vacuum filtration, and dried at 50° C. under vacuum to give 55.37 g (79% yield) of 2,5-dibromo-benzene-sulfonyl chloride. ¹H NMR (CDCl₃): 7.66 (dd, 8.4, 2.3 Hz, 1H), 7.72 (d, 8.4 Hz, 1H), 8.30 (d, 2.3 Hz, 1H).

### Example 2

### D100016-98, 113

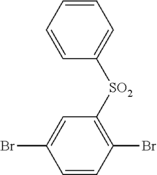

A 100 mL round-bottom flask equipped with a reflux condenser, stirring bar, and gas inlet was charged with 2,5-dibromo-benzene-sulfonyl chloride (10 g, 30 mmoles) and benzene (30 mL). Aluminum chloride (4 g, 30 mmoles) was added and the mixture stirred until dissolved. The solution was heated to reflux for 2 hours. The solution was cooled to room temperature and poured onto 150 g ice mixed with 50 mL hydrochloric acid. The precipitated solids were collected by filtration and washed with water. The filtrate was extracted with ether and the organic extracts were washed twice with water, dried with magnesium sulfate, filtered, and evaporated. The precipitated and extracted products were combined to give 11.33 g of impure product. The solids were recrystallized from ethanol after treating with decolorizing carbon to give 3.82 g (34% yield) of 2,5-dibromo-diphenylsulfone. ¹H NMR (DMSO-d₆): 7.65 (dd, 7.7, 7.4 Hz, 2H), 7.76 (t, 7.4 Hz, 1H), 7.76 (d, 8.4 Hz, 1H), 7.85 (dd, 8.4, 2.4 Hz, 1H), 7.98 (d, 7.7 Hz, 2H), 8.40 (d, 2.4 Hz, 1H).

This reaction was repeated on a larger scale (100 mmol) with 6 hours at reflux and worked up by extracting the hydrolyzed mixture with dichloromethane then drying with sodium carbonate. The impure product was recrystallized from ethanol to give 13.7 g (36% yield). ¹³C NMR (CDCl3): 120.23 (C), 122.31 (C), 129.21 (2 CH), 129.39 (2 CH), 134.20 (CH), 134.46 (CH), 137.38 (CH), 137.92 (CH), 139.69 (C), 142.04 (C). MS (M+H⁺): m/e 376.8654 (100%), 374.8680 (50%), 378.8630 (49%); exact mass for C₁₂H₉O₂Br₂S₁, 376.8670 (100%), 374.8690 (51.4%), 378.8649 (48.6).

### Example 3

### D100016-140

Inside a glove box, a 100 mL round-bottom flask equipped with a reflux condenser, stirring bar, and gas inlet was charged with 2,5-dibromo-benzene-sulfonyl chloride (15.05 g, 45 mmoles), benzene (15 mL), and anhydrous nitromethane (45 mL). Aluminum chloride (6.67 g, 50 mmoles) was added and the mixture stirred until dissolved. The solution was heated to 100° C. overnight. The solution was cooled to room temperature and poured onto 100 g ice mixed with 50 mL hydrochloric acid. The mixture was extracted twice with dichloromethane. The organic extracts were washed twice with water, dried with sodium carbonate, filtered, and evaporated to give 16.28 g (96%). The solids were recrystallized from ethanol after treating with decolorizing carbon to give 13.48 g (80% yield) of 2,5-dibromo-diphenylsulfone. ¹H NMR (DMSO-d₆): 7.65 (ddd, 8.4, 7.4, 2.0 Hz, 2H), 7.76 (tt, 7.4, 1.2 Hz, 1H), 7.76 (d, 8.4 Hz, 1H), 7.85 (dd, 8.4, 2.4 Hz, 1H), 7.98 (ddd, 8.4, 2.0 1.2 Hz, 2H), 8.40 (d, 2.4 Hz, 1H).

### Example 4

### D100016-116, 118, 120

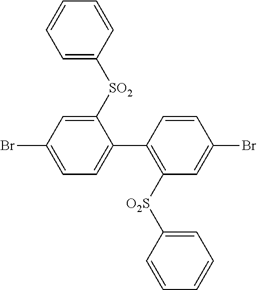

Inside a glove box, a 100 mL round-bottom flask equipped with a stirring bar, reflux condenser, and a septum was charged with 2,5-dibromo-diphenylsulfone (7.52 g, 20 mmoles), activated copper powder (2.54 g), and DMAc (20 mL). The flask was heated to 120° C. under nitrogen for 2 hours. The mixture was cooled to room temperature, poured into acetone, and filtered using a 5 μm PTFE membrane filter. The solvents were evaporated and the residue dried under high vacuum to give 6.40 g solids. The mixture was purified by column chromatography using silica gel and dichloromethane to give 1.74 g (29% yield) of 2,2′-bis-benzenesulfonyl-4,4′-dibromo-biphenyl. ^{1H} NMR (DMSO-d₆): 6.89 (d, 8.2 Hz, 2H), 7.54 (m, 4H), 7.55 (m, 4H), 7.69 (m, 2H), 7.86 (dd, 8.2, 2.1 Hz, 2H), 8.22 (d, 2.1 Hz, 2H).

The reaction was repeated several times at 100-120° C. varying the time from 3-7 hours without a substantial change in the yield after column chromatography. The combined products (9.46 g) were recrystallized twice from toluene to give 5.44 g pure compound. ¹³C NMR (DMSO-d₆): 122.30 (2C—Br), 127.68 (4CH), 129.40 (4CH), 131.36 (2CH), 133.68 (2CH), 133.93 (2CH), 135.06 (2C), 135.38 (2CH), 140.25 (2C—SO₂—), 140.92 (2C—SO₂—). MS (M+H⁺): m/e 592.8907 (100%), 590.8933 (49%), 594.8884 (56%); exact mass for C₂₄H₁₇O₄Br₂S₂, 592.8909 (100%), 590.8930 (51.4%), 594.8889 (48.6).

### 4,4′-Dibromo-biphenyl-2,2′-disulfonyl dichloride (D100016-131)

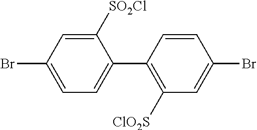

Inside a glove box, a 200 mL round-bottom flask equipped with a reflux condenser, stirring bar, and gas inlet was charged with 4,4′-dibromo-biphenyl-2,2′-disulfonic acid, sodium salt from Example 1 (51.6 g, 0.100 moles), phosphorus pentachloride (46 g, 0.22 moles), and phosphorus oxychloride (30 mL). The mixture was heated to a mild reflux (152° C.) for 6 hours under nitrogen. The mixture was poured onto ice (1 kg) and stirred until the solids were finely divided. The solids were collected by vacuum filtration, washed well with water, and air dried on the filter then dried under vacuum at 75° C. to give 50.7 g. The solids were recrystallized from toluene after treating with decolorizing carbon, collected by vacuum filtration, and dried under vacuum at 60=° C. to give 42.59 g (84% yield) of 4,4′-dibromo-biphenyl-2,2′-disulfonyl dichloride. ¹H NMR (CDCl₃): 7.38 (d, 8.2 Hz, 2H), 7.91 (dd, 8.2, 2.0 Hz, 2H), 8.37 (d, 2.0 Hz, 2H).

### Example 5

### D100016-151, 153

Inside a glove box, a 125 mL round-bottom flask equipped with a stirring bar, reflux condenser, and gas inlet was charged with 4,4′-dibromo-biphenyl-2,2′-disulfonyl dichloride (10.18 g, 20 mmoles) and aluminum chloride (5.87 g, 44 mmoles). Benzene (14 mL), and anhydrous nitromethane (40 mL) were added and the mixture stirred until dissolved. The solution was heated to 100° C. for about 8 hours. The solution was cooled to room temperature and poured onto 200 g ice mixed with 100 mL hydrochloric acid. The mixture was extracted several times with dichloromethane. The organic extracts were washed twice with water, dried with sodium carbonate, filtered, and evaporated to give 11.75 g (99%). The mixture was purified by column chromatography using silica gel and dichloromethane (R_{f} 0.32) to give 8.73 g (74% yield) of 2,2′-bis-benzenesulfonyl-4,4′-dibromo-biphenyl.

The reaction was repeated on a larger scale to give 24.37 g (87% yield) and purified by chromatography to give 17.2 g (61% yield). The combined products were recrystallized from toluene after treating with decolorizing carbon to give 23.02 g (89% mass balance) of 2,2′-bis-benzenesulfonyl-4,4′-dibromo-biphenyl.

### Example 6

### D100016-125

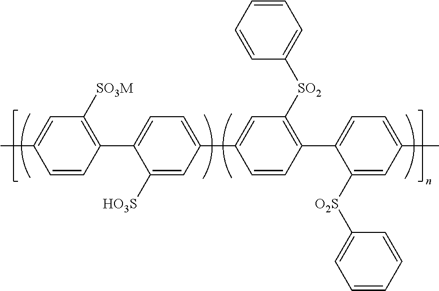

Inside the glove box, a 100 mL round-bottom flask equipped with a large stirring bar and a septum was charged with bis(1,5-cyclooctadiene)nickel(0) (4.58 g, 16.64 mmoles), cyclooctadiene (1.80 g, 16.64 mmoles), 2,2′-bipyridine (2.60 g, 16.64 mmoles), and DMAc (20 mL). The flask was heated to 70° C. under nitrogen for 30 minutes to give a dark violet-colored solution. Inside the glove box, a 50 mL round-bottom flask equipped with a septum was charged with 4,4′-dibromo-biphenyl-2,2′-disulfonic acid, sodium salt (2.126 g, 4.119 mmoles), 2,2′-bis-benzenesulfonyl-4,4′-dibromo-biphenyl (2.440 g, 4.119 mmoles), and DMAc (30 mL). This flask was heated to 70° C. to dissolve the monomers and the solution was added dropwise by cannula to the reaction flask under nitrogen. After reacting overnight at 70° C., the reaction mixture was poured into concentrated hydrochloric acid to precipitate the polymer and the mixture was chopped in a blender to disperse the polymer into particles. The polymer was collected by vacuum filtration, washed with concentrated hydrochloric acid followed by water, and dried in a vacuum oven at 70° C. under nitrogen purge to give 3.25 g (100% yield) of the 1:1 copolymer, poly[(4,4′-biphenylene-2,2′-disulfonic acid)-co-(2,2′-bis-benzenesulfonyl-4,4′-biphenylene)]. The molecular weight distribution was measured by gel permeation chromatography in DMAc: Mₙ 21,000, M_{w} 32,500, M_{z} 49,200; [η] 0.65. Thermo-gravimetric analysis (10° C./min scan rate) showed an onset of decomposition at 225° C. under nitrogen.

### Example 7

### D100016-139

Inside the glove box, a 100 mL round-bottom flask equipped with a large stirring bar and a septum was charged with bis(1,5-cyclooctadiene)nickel(0) (4.45 g, 16.16 mmoles), cyclooctadiene (1.75 g, 16.16 mmoles), 2,2′-bipyridine (2.52 g, 16.16 mmoles), and DMAc (20 mL). The flask was heated to 70° C. under nitrogen for 30 minutes to give a dark violet-colored solution. Inside the glove box, a 50 mL round-bottom flask equipped with a septum was charged with 4,4′-dibromo-biphenyl-2,2′-disulfonic acid, sodium salt (2.064 g, 4 mmoles), 2,2′-bis-benzenesulfonyl-4,4′-dibromo-biphenyl (2.369 g, 4 mmoles), and DMAc (30 mL). This flask was heated to 70° C. to dissolve the monomers and the solution was added dropwise by cannula to the reaction flask under nitrogen. The monomers were washed in with additional DMAc (5 mL). The polymerization quickly began to develop gel, so it was diluted with additional DMAc (10 mL) and the temperature was increased to 100° C. overnight. The reaction mixture was poured into concentrated hydrochloric acid to precipitate the polymer and the mixture was chopped in a blender to disperse the polymer into particles. The polymer was collected by vacuum filtration, washed with concentrated hydrochloric acid followed by water then methanol, and dried in a vacuum oven at 70° C. under nitrogen purge to give 1.54 g (52% yield) of the 1:1 copolymer, poly[(4,4′-biphenylene-2,2′-disulfonic acid)-co-(2,2′-bis-benzenesulfonyl-4,4′-biphenylene)]. The molecular weight distribution was measured by gel permeation chromatography in DMAc: Mₙ 26,000, M_{w} 39,100, M_{z} 56,400; [η] 0.96.

The copolymer (0.99 g) was dissolved in DMAc (12.4 mL) using heat and filtered using a glass microfiber syringe filter into a polymethylpentene Petri dish. The dish was placed on a leveled drying stage in a nitrogen-purged drying chamber. The dried membrane lifted free of the dish on its own then was dried further at 80° C. in a nitrogen-purged vacuum oven. The membrane was treated with 15% nitric acid overnight, then washed with deionized water three times until neutral. The membrane was sectioned for through-plane conductivity measurements as shown in Table 1.

TABLE 1

| Dimensions | | | In-Plane |
|---|---|---|---|
| Thickness | Temperature | Relative | Conductivity |
| μm | ° C. | Humidity % | mS/cm |
| 124 | 80 | 95 | 63.2 |
| | 80 | 50 | 2.16 |

### Example 8

### D100016-149

Inside the glove box, a 125 mL round-bottom flask equipped with a large stirring bar and a septum was charged with bis(1,5-cyclooctadiene)nickel(0) (5.56 g, 20.2 mmoles), cyclooctadiene (2.19 g, 20.2 mmoles), 2,2′-bipyridine (3.16 g, 20.2 mmoles), and DMAc (40 mL). The flask was heated to 70° C. under nitrogen for 30 minutes to give a dark violet-colored solution. Inside the glove box, a 100 mL round-bottom flask equipped with a septum was charged with 4,4′-dibromo-biphenyl-2,2′-disulfonic acid, sodium salt (2.064 g, 4 mmoles), 2,2′-bis-benzenesulfonyl-4,4′-dibromo-biphenyl (3.554 g, 6 mmoles), and DMAc (40 mL). This flask was heated to 70° C. to dissolve the monomers and the solution was added dropwise by cannula to the reaction flask under nitrogen. After reacting overnight at 70° C., the mixture was black.

Inside the glove box, an additional portion of catalyst was prepared in a septum-sealed vial using bis(1,5-cyclooctadiene)nickel(0) (0.56 g, 2.0 mmoles), cyclooctadiene (0.22 g, 2.0 mmoles), 2,2′-bipyridine (0.32 g, 2.0 mmoles), and DMAc (5 mL). The vial was heated to 70° C. to dissolve the catalyst and transferred to the reaction flask by a cannula under nitrogen. The dark-violet reaction mixture again turned black after a short time. The reaction mixture was poured into concentrated hydrochloric acid to precipitate the polymer and the mixture was chopped in a blender to disperse the polymer into particles. The polymer was collected by vacuum filtration, washed with concentrated hydrochloric acid followed by water then cyclohexane, and dried in a vacuum oven at 70° C. under nitrogen purge to give 3.25 g (85% yield) of the 2:3 copolymer, poly[(4,4′-biphenylene-2,2′-disulfonic acid)-co-(2,2′-bis-benzenesulfonyl-4,4′-biphenylene)]. The molecular weight distribution was measured by gel permeation chromatography in DMAc: Mₙ 23,500, M_{w} 46,300, M_{z} 75,200; [η] 1.44. Thermo-gravimetric analysis (10° C./min scan rate) showed an onset of decomposition at 220° C. under nitrogen.

The copolymer (1.0 g) was dissolved in DMF (20 mL) and filtered using a glass microfiber syringe filter into a polymethylpentene Petri dish. The dish was placed on a leveled drying stage in a nitrogen-purged drying chamber. The dried membrane lifted free of the dish on its own. The membrane was treated with 15% nitric acid overnight, washed with deionized water, then treated with fresh 15% nitric acid for several hours. The membrane was washed with deionized water until neutral. The membrane was sectioned for through-plane conductivity measurements as shown in Table 2.

TABLE 2

| Dimensions | | | Through-Plane |
|---|---|---|---|
| Thickness | Temperature | Relative | Conductivity |
| μm | ° C. | Humidity % | mS/cm |
| 107 | 80 | 95 | 64.4 |
| | 80 | 50 | 6.63 |
| | 80 | 25 | 1.10 |
| | 120 | 25 | 1.75 |

### Example 9

### D100016-199

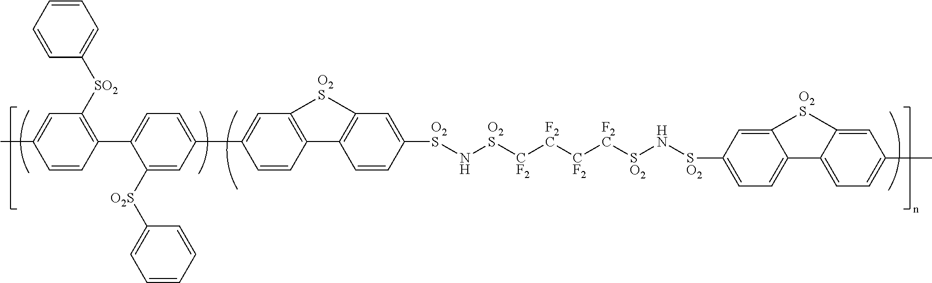

Inside the glove box, a 100 mL round-bottom flask equipped with a large stirring bar and a septum was charged with bis(1,5-cyclooctadiene)nickel(0) (2.42 g, 8.8 mmoles), cyclooctadiene (0.95 g, 8.8 mmoles), 2,2′-bipyridine (1.37 g, 8.88 mmoles), and DMAc (10 mL). The flask was heated to 70° C. under nitrogen for 30 minutes to give a dark violet-colored solution. Inside the glove box, a 50 mL round-bottom flask equipped with a septum was charged with N,N′-bis(7-bromo-dibenzothiophene-5,5-dioxide-3-sulfonyl)-octafluorobutane-1,4-disulfonamide, sodium salt (2.24 g, 2 mmoles), 2,2′-bis-benzenesulfonyl-4,4′-dibromobiphenyl (1.18 g, 2 mmoles), and DMAc (20 mL). This flask was heated to 70° C. to dissolve the monomers and the solution was added dropwise by cannula to the reaction flask under nitrogen. After reacting overnight at 70° C., the viscous mixture was black and gelled upon cooling to room temperature.

The reaction mixture was poured into concentrated hydrochloric acid to precipitate the polymer and rinsed from the flask with methanol. The mixture was chopped in a blender to disperse the polymer into a granular solid. The polymer was collected by vacuum filtration then washed with methanol and water. The polymer was returned to the blender where it was washed again with concentrated hydrochloric acid and methanol then collected and washed with methanol and water. After air drying overnight, the polymer was dissolved in DMAc (50 mL). The solution was filtered then poured into concentrated hydrochloric acid in the blender rinsing the flask with concentrated hydrochloric acid. The polymer was collected by vacuum filtration and washed with water. The polymer was washed on the filter with concentrated hydrochloric acid followed by water. After air drying, the polymer was dried in a vacuum oven at 50° C. under nitrogen purge to give 2.10 g (78% yield) of the 1:1 copolymer. The molecular weight distribution was measured by gel permeation chromatography in DMAc: Mₙ 59,500, M_{w} 112,000, M_{z} 204,000; [η] 0.46. Thermo-gravimetric analysis (10° C./min scan rate) showed an onset of decomposition at 250° C. under nitrogen.

The copolymer (0.75 g) was dissolved in DMF (12 mL) heating to 100° C. and filtered using a glass microfiber syringe filter into a polymethylpentene Petri dish. The dish was placed on a leveled drying stage in a nitrogen-purged drying chamber and dried until the membrane was set. The membrane was dried in a 100° C. vacuum oven under nitrogen purge, which caused it to lift free of the dish on its own. The membrane was treated with 15% nitric acid overnight, washed with deionized water, then treated with fresh 15% nitric acid overnight. The membrane was washed with deionized water until neutral and air dried. The membrane was sectioned for through-plane and in-plane conductivity measurements as shown in Table 3.

TABLE 3

| Tem- | | | Through- | Dimensions | In-Plane |
|---|---|---|---|---|---|
| per- | Relative | Dimensions | Plane | Thickness × | Conduc- |
| ature | Humidity | Thickness | Conductivity | Width | tivity |
| ° C. | % | μm | mS/cm | μm × mm | mS/cm |
| 80 | 95 | 117 | 55.8 | 74 × 15.4 | 195 |
| 80 | 50 | (2 ply) | 1.9 | | 2.9 |

What is claimed is:

1. A process to prepare a copolymer comprising polymerizing a monomer of Formula (II) 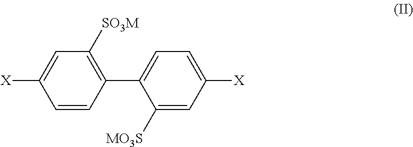
and a monomer of Formula (III) 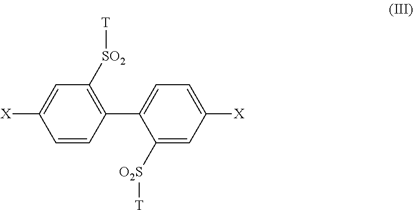
wherein T is a bulky aromatic group, X is independently Br or Cl, and M is one or more of monovalent cation.

2. The process of claim 1 wherein the polymerization is done in the presence of a zerovalent transition metal and a neutral ligand in the form of a complex.

3. The process of claim 1 wherein the zerovalent transition metal is palladium or nickel.

4. The process of claim 1 wherein the zerovalent transition metal is bis(1,5-cyclooctadiene)nickel(0) and the neutral ligand is 2,2′-bipyridine.

5. The process of claim 1 wherein an accelerator is present.

6. The process of claim 1 wherein the polymerization is performed in a solvent.

7. The process of claim 6 wherein the solvent is one or more of N,N-dimethylformamide, toluene, tetrahydrofuran, acetone, anisole, acetonitrile, N,N-dimethylacetamide, or N-methylpyrrolidinone.

8. The process of claim 1 wherein the copolymer has a weight average molecular weight of at least 30,000.
